(19) United States
(12) Patent Application Publication
(10) Pub. No.: US 2026/0329961 A1
(43) Pub. Date: Oct. 22, 2026

(54) SOLVING BOOLEAN SATISFIABILITY PROBLEMS USING A GPU-CPU HYBRID SYSTEM

(71) Applicant: NVIDIA CORPORATION, Santa Clara, CA (US)

(72) Inventors: Steve DAI, Union City, CA (US); Brucek KHAILANY, Austin, TX (US); Cunxi YU, College Park, MD (US)

(21) Appl. No.: 19/282,951

(22) Filed: Jul. 28, 2025

Related U.S. Application Data
(60) Provisional application No. 63/792,199, filed on Apr. 21, 2025.

(51) Int. Cl. G06F 17/11; G06N 20/00

(52) U.S. Cl. CPC G06F 17/11; G06N 20/00

(57) ABSTRACT

The disclosed method for solving a Boolean satisfiability (SAT) problem includes receiving a SAT problem, generating, based on the SAT problem, a SAT problem matrix, performing, based on the SAT problem matrix, one or more operations to train an untrained machine learning model to generate a trained machine learning model and gradient data, wherein the trained machine learning model comprises a trained partial assignment matrix, and generating, based on the trained partial assignment matrix and the gradient data and using one or more SAT solvers, a SAT solver output.

### CROSS-REFERENCE TO RELATED APPLICATIONS

This application claims priority benefit of the United States Provisional Patent Application titled, “TECHNIQUES FOR ACCELERATING GRADIENT-GUIDED BOOLEAN SATISFIABILITY SOLVING ON GPU-CPU HYBRID SYSTEMS,” filed on Apr. 21, 2025, and having Ser. No. 63/792,199. The subject matter of this related application is hereby incorporated herein by reference.

### BACKGROUND

### Technical Field

Embodiments of the present disclosure relate generally to computer science, artificial intelligence and machine learning, and, more specifically, to solving Boolean satisfiability problems using a GPU-CPU hybrid system.

### Description of the Related Art

Boolean satisfiability (SAT) refers to the problem of determining whether there exists an assignment of true or false values to a set of variables in a logical formula such that the formula evaluates to true. A related outcome is unsatisfiability (UNSAT), which indicates that no such assignment exists and the formula cannot be satisfied. SAT and UNSAT problems appear in many areas of computer science and engineering. Applications include but are not limited to hardware verification, where SAT solvers check whether circuit designs satisfy correctness properties or prove that certain error conditions cannot occur, such as verifying that two signals in a digital circuit cannot simultaneously carry conflicting values. In software verification, SAT solvers analyze logical models of program behavior to detect potential faults or prove safety, for example by proving that a memory buffer cannot be accessed out of bounds. In electronic design automation, SAT solvers assist in optimizing chip layouts and generating test cases, such as identifying corner-case input patterns for validating integrated circuits. In artificial intelligence, SAT solvers are used in planning, scheduling, and constraint satisfaction tasks, such as generating valid sequences of actions for a robot to complete a goal or allocating limited resources across multiple competing tasks. SAT problems often involve large sets of variables and constraints, making efficient solution techniques important for practical applications.

Conventional approaches for solving SAT problems typically rely on conflict-driven clause learning (CDCL) algorithms that perform systematic search through the space of possible variable assignments. CDCL algorithms divide the solving process into distinct stages, including unit propagation, clause learning, and backtracking. The unit propagation stage infers variable assignments that are logically required to satisfy the current set of clauses. The clause learning stage analyzes conflicts encountered during search and generates additional clauses to prune unproductive parts of the search space. The backtracking stage undoes variable assignments and explores alternative branches in the search tree. For example, conventional CDCL solvers often use variable activity heuristics to prioritize which variable to branch on next and employ restart policies to periodically reset the search state and improve coverage of the search space.

One drawback of the conventional approaches for solving SAT problems is the sequential nature of the CDCL algorithms, which limits the ability of the CDCL algorithms to fully leverage modern parallel computing architectures. While CDCL algorithms include advanced heuristics and clause learning to improve search efficiency, the core solving process typically proceeds by making one branching decision at a time, followed by unit propagation and backtracking as needed. The step-by-step search makes it challenging to utilize highly parallel processors, such as graphics processing units (GPUs), to accelerate the core search. For example, although certain preprocessing steps or specific subcomponents, such as Boolean constraint propagation, can be parallelized to some extent, the decision and clause learning loop included in CDCL algorithms remains largely sequential. The limitation is particularly pronounced in applications where solving large or complex SAT problems in reduced time is needed, such as formal verification of hardware designs with many corner cases, or software analysis tasks with large code bases and extensive control paths.

As the foregoing illustrates, what is needed in the art are more effective techniques for solving SAT problems.

### SUMMARY

According to some embodiments, a computer-implemented method for solving a Boolean satisfiability (SAT) problem includes receiving a SAT problem. The method further includes generating, based on the SAT problem, a SAT problem matrix. Additionally, the method includes performing, based on the SAT problem matrix, one or more operations to train an untrained machine learning model to generate a trained machine learning model and gradient data, wherein the trained machine learning model comprises a trained partial assignment matrix. Furthermore, the method includes generating, based on the trained partial assignment matrix and the gradient data and using one or more SAT solvers, a SAT solver output.

Further embodiments provide, among other things, non-transitory computer-readable storage media storing instructions and systems configured to implement the method set forth above.

At least one technical advantage of the disclosed techniques relative to the prior art is that the disclosed techniques enable parallelized SAT solving by combining gradient-based training of candidate variable assignments with seeded initialization of multiple SAT solver threads. Instead of relying solely on the inherently sequential decision-making structure of conventional SAT solvers, such as conflict-driven clause learning (CDCL) algorithms, the disclosed techniques include training a real-valued partial assignment matrix using differentiable loss functions and gradient-based optimization, then uses the resulting high-confidence assignments to initialize multiple parallel SAT solver threads. The disclosed techniques decouple the exploration of promising solution regions from the rigid sequential branching process, enabling effective use of highly parallel architectures, such as graphics processing units (GPUs) during training and multithreaded central processing unit (CPU) execution during solving. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, can be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a block diagram of a computer system configured to implement one or more aspects of the present disclosure;

FIG. 2 is a block diagram of a parallel processing unit included in the parallel processing subsystem of FIG. 1, according to various embodiments of the present disclosure;

FIG. 3 is a block diagram of a general processing cluster included in the parallel processing unit of FIG. 2, according to various embodiments of the present disclosure;

FIG. 4 is a block diagram of a computer system configured to implement one or more aspects of various embodiments;

FIG. 5 is a more detailed illustration of the model trainer training the SAT solver model of FIG. 4, according to various embodiments;

FIG. 6 is a simplified depiction of the matrix computations performed by the SAT solver model of FIG. 4, according to various embodiments;

FIG. 7 is a more detailed illustration of the SAT solving application of FIG. 4, according to various embodiments;

FIG. 8 is a flow diagram of method steps for generating gradient data and partial assignment matrix, according to various embodiments;

FIG. 9 is a flow diagram of method steps for training a SAT solver model, according to various embodiments; and

FIG. 10 is a flow diagram of method steps for generating SAT solver output, according to various embodiments.

### DETAILED DESCRIPTION

In the following description, numerous specific details are set forth to provide a more thorough understanding of the various embodiments. However, it will be apparent to one skilled in the art that the concepts can be practiced without one or more of these specific details.

### General Overview

Embodiments of the present disclosure provide techniques for solving SAT problems using a GPU-CPU hybrid solving system. The hybrid solving system synergistically combines GPU-driven differentiable optimization with CPU-based combinatorial search. In some embodiments, a model trainer trains a SAT solver model to generate gradient data and a partial assignment matrix based on a SAT problem using GPU-driven differentiable optimization. During the training of the SAT solver, a SAT problem encoder processes the SAT problem and generates a SAT problem matrix. The SAT solver model includes, without limitation, the partial assignment matrix, a result matrix calculator, and a satisfiability matrix generator. The result matrix calculator performs a matrix multiplication based on the SAT problem matrix and the partial assignment matrix and calculates the result matrix, which in some embodiments is performed using one or more GPUs. The satisfiability matrix generator processes the result matrix and generates the satisfiability matrix. A loss calculator calculates a loss based on the satisfiability matrix. The model trainer uses the loss to iteratively update the partial assignment matrix until one or more stopping criteria is met. Once the training stops, the model trainer generates the gradient data and stores the gradient data and the partial assignment matrix. A SAT solving application processes the partial assignment matrix, the gradient data, and the SAT problem and generates a SAT solver output. The SAT solving application includes, without limitation, a thread manager and one or more SAT solvers. The thread manager processes the partial assignment matrix and the gradient data and generates a thread data. The SAT solving application uses the one or more SAT solvers to process the SAT problem based on the thread data and generate the SAT solver output, which in some embodiments include performing a combinatorial search on one or more CPU threads.

The SAT solving techniques of the present disclosure have many real-world applications. For example, the SAT solving techniques could be used in hardware verification tools for checking digital circuit correctness. As another example, the SAT solving techniques could be used in software analysis systems for exploring execution paths. The SAT solving techniques could also be used in artificial intelligence systems for planning and scheduling tasks encoded as logical constraints.

The above examples are not in any way intended to be limiting. As persons skilled in the art will appreciate, as a general matter, the SAT solving techniques described herein can be implemented in any suitable application.

### System Overview

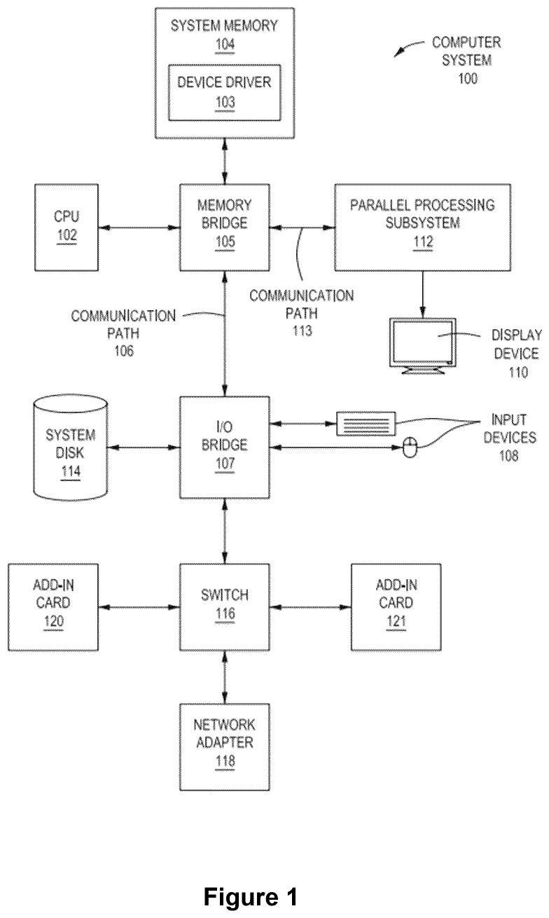

FIG. 1 is a block diagram of a computer system 100 configured to implement one or more aspects of the present disclosure. As shown, computer system 100 includes, without limitation, a central processing unit (CPU) 102 and a system memory 104 coupled to a parallel processing subsystem 112 via a memory bridge 105 and a communication path 113. Memory bridge 105 is further coupled to an I/O (input/output) bridge 107 via a communication path 106, and I/O bridge 107 is, in turn, coupled to a switch 116. As persons skilled in the art will appreciate, computer system 100 can be any type of technically feasible computer system, including, without limitation, a server machine, a server platform, a desktop machine, laptop machine, or a hand-held/mobile device. Persons skilled in the art also will appreciate that computer system 100 or systems similar to computer system 100 can be incorporated into a vehicle or machine to facilitate driving, steering, or otherwise controlling that vehicle or machine, as the case may be.

In operation, I/O bridge 107 is configured to receive user input information from input devices 108, such as a keyboard or a mouse, and forward the input information to CPU 102 for processing via communication path 106 and memory bridge 105. Switch 116 is configured to provide connections between I/O bridge 107 and other components of the computer system 100, such as a network adapter 118 and various add-in cards 120 and 121.

As also shown, I/O bridge 107 is coupled to a system disk 114 that may be configured to store content and applications and data for use by CPU 102 and parallel processing subsystem 112. As a general matter, system disk 114 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. Finally, although not explicitly shown, other components, such as universal serial bus or other port connections, compact disc drives, digital versatile disc drives, film recording devices, and the like, may be connected to I/O bridge 107 as well.

In various embodiments, memory bridge 105 may be a Northbridge chip, and I/O bridge 107 may be a Southbrige chip. In addition, communication paths 106 and 113, as well as other communication paths within computer system 100, may be implemented using any technically suitable protocols, including, without limitation, AGP (Accelerated Graphics Port), HyperTransport, or any other bus or point-to-point communication protocol known in the art.

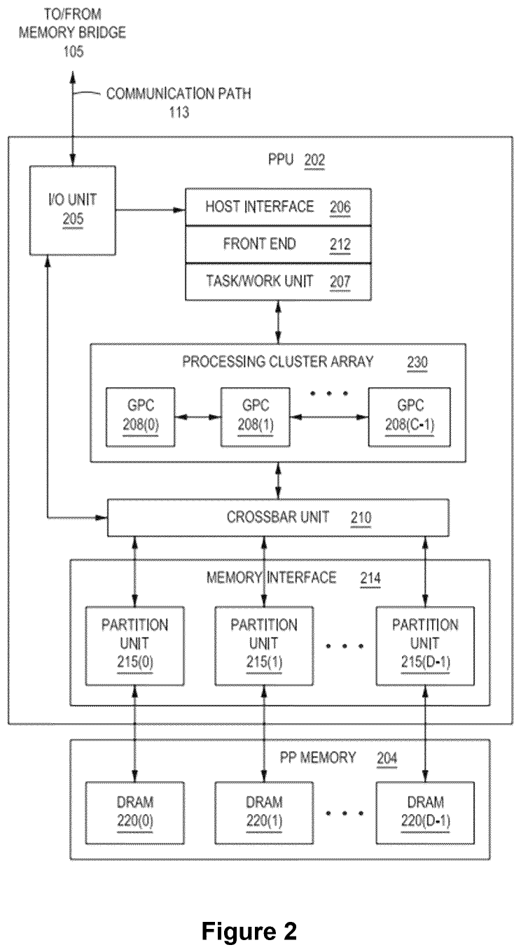

In some embodiments, parallel processing subsystem 112 comprises a graphics subsystem that delivers pixels to a display device 110 that may be any conventional cathode ray tube, liquid crystal display, light-emitting diode display, or the like. In such embodiments, the parallel processing subsystem 112 incorporates circuitry optimized for graphics and video processing, including, for example, video output circuitry. As described in greater detail below in FIG. 2, such circuitry may be incorporated across one or more parallel processing units (PPUs) included within parallel processing subsystem 112. In other embodiments, the parallel processing subsystem 112 incorporates circuitry optimized for general purpose and/or compute processing. Again, such circuitry may be incorporated across one or more PPUs included within parallel processing subsystem 112 that are configured to perform such general purpose and/or compute operations. In yet other embodiments, the one or more PPUs included within parallel processing subsystem 112 may be configured to perform graphics processing, general purpose processing, and compute processing operations. System memory 104 includes at least one device driver 103 configured to manage the processing operations of the one or more PPUs within parallel processing subsystem 112.

In various embodiments, parallel processing subsystem 112 may be integrated with one or more other the other elements of FIG. 1 to form a single system. For example, parallel processing subsystem 112 may be integrated with CPU 102 and other connection circuitry on a single chip to form a system on chip (SoC).

It will be appreciated that the system shown herein is illustrative and that variations and modifications are possible. The connection topology, including the number and arrangement of bridges, the number of CPUs 102, and the number of parallel processing subsystems 112, may be modified as desired. For example, in some embodiments, system memory 104 could be connected to CPU 102 directly rather than through memory bridge 105, and other devices would communicate with system memory 104 via memory bridge 105 and CPU 102. In other alternative topologies, parallel processing subsystem 112 may be connected to I/O bridge 107 or directly to CPU 102, rather than to memory bridge 105. In still other embodiments, I/O bridge 107 and memory bridge 105 may be integrated into a single chip instead of existing as one or more discrete devices. Lastly, in certain embodiments, one or more components shown in FIG. 1 may not be present. For example, switch 116 could be eliminated, and network adapter 118 and add-in cards 120, 121 would connect directly to I/O bridge 107.

FIG. 2 is a block diagram of a parallel processing unit (PPU) 202 included in the parallel processing subsystem 112 of FIG. 1, according to various embodiments of the present disclosure. Although FIG. 2 depicts one PPU 202, as indicated above, parallel processing subsystem 112 may include any number of PPUs 202. As shown, PPU 202 is coupled to a local parallel processing (PP) memory 204. PPU 202 and PP memory 204 may be implemented using one or more integrated circuit devices, such as programmable processors, application specific integrated circuits (ASICs), or memory devices, or in any other technically feasible fashion.

In some embodiments, PPU 202 comprises a graphics processing unit (GPU) that may be configured to implement a graphics rendering pipeline to perform various operations related to generating pixel data based on graphics data supplied by CPU 102 and/or system memory 104. When processing graphics data, PP memory 204 can be used as graphics memory that stores one or more conventional frame buffers and, if needed, one or more other render targets as well. Among other things, PP memory 204 may be used to store and update pixel data and deliver final pixel data or display frames to display device 110 for display. In some embodiments, PPU 202 also may be configured for general-purpose processing and compute operations.

In operation, CPU 102 is the master processor of computer system 100, controlling and coordinating operations of other system components. In particular, CPU 102 issues commands that control the operation of PPU 202. In some embodiments, CPU 102 writes a stream of commands for PPU 202 to a data structure (not explicitly shown in either FIG. 1 or FIG. 2) that may be located in system memory 104, PP memory 204, or another storage location accessible to both CPU 102 and PPU 202. A pointer to the data structure is written to a pushbuffer to initiate processing of the stream of commands in the data structure. The PPU 202 reads command streams from the pushbuffer and then executes commands asynchronously relative to the operation of CPU 102. In embodiments where multiple pushbuffers are generated, execution priorities may be specified for each pushbuffer by an application program via device driver 103 to control scheduling of the different pushbuffers.

As also shown, PPU 202 includes an I/O (input/output) unit 205 that communicates with the rest of computer system 100 via the communication path 113 and memory bridge 105. I/O unit 205 generates packets (or other signals) for transmission on communication path 113 and also receives all incoming packets (or other signals) from communication path 113, directing the incoming packets to appropriate components of PPU 202. For example, commands related to processing tasks may be directed to a host interface 206, while commands related to memory operations (e.g., reading from or writing to PP memory 204) may be directed to a crossbar unit 210. Host interface 206 reads each pushbuffer and transmits the command stream stored in the pushbuffer to a front end 212.

As mentioned above in conjunction with FIG. 1, the connection of PPU 202 to the rest of computer system 100 may be varied. In some embodiments, parallel processing subsystem 112, which includes at least one PPU 202, is implemented as an add-in card that can be inserted into an expansion slot of computer system 100. In other embodiments, PPU 202 can be integrated on a single chip with a bus bridge, such as memory bridge 105 or I/O bridge 107. Again, in still other embodiments, some or all of the elements of PPU 202 may be included along with CPU 102 in a single integrated circuit or system of chip (SoC).

In operation, front end 212 transmits processing tasks received from host interface 206 to a work distribution unit (not shown) within task/work unit 207. The work distribution unit receives pointers to processing tasks that are encoded as task metadata (TMD) and stored in memory. The pointers to TMDs are included in a command stream that is stored as a pushbuffer and received by the front end unit 212 from the host interface 206. Processing tasks that may be encoded as TMDs include indices associated with the data to be processed as well as state parameters and commands that define how the data is to be processed. For example, the state parameters and commands could define the program to be executed on the data. The task/work unit 207 receives tasks from the front end 212 and ensures that GPCs 208 are configured to a valid state before the processing task specified by each one of the TMDs is initiated. A priority may be specified for each TMD that is used to schedule the execution of the processing task. Processing tasks also may be received from the processing cluster array 230. Optionally, the TMD may include a parameter that controls whether the TMD is added to the head or the tail of a list of processing tasks (or to a list of pointers to the processing tasks), thereby providing another level of control over execution priority.

PPU 202 advantageously implements a highly parallel processing architecture based on a processing cluster array 230 that includes a set of C general processing clusters (GPCs) 208, where C□1. Each GPC 208 is capable of executing a large number (e.g., hundreds or thousands) of threads concurrently, where each thread is an instance of a program. In various applications, different GPCs 208 may be allocated for processing different types of programs or for performing different types of computations. The allocation of GPCs 208 may vary depending on the workload arising for each type of program or computation.

Memory interface 214 includes a set of D of partition units 215, where D□1. Each partition unit 215 is coupled to one or more dynamic random access memories (DRAMs) 220 residing within PPM memory 204. In one embodiment, the number of partition units 215 equals the number of DRAMs 220, and each partition unit 215 is coupled to a different DRAM 220. In other embodiments, the number of partition units 215 may be different than the number of DRAMs 220. Persons of ordinary skill in the art will appreciate that a DRAM 220 may be replaced with any other technically suitable storage device. In operation, various render targets, such as texture maps and frame buffers, may be stored across DRAMs 220, allowing partition units 215 to write portions of each render target in parallel to efficiently use the available bandwidth of PP memory 204.

A given GPCs 208 may process data to be written to any of the DRAMs 220 within PP memory 204. Crossbar unit 210 is configured to route the output of each GPC 208 to the input of any partition unit 215 or to any other GPC 208 for further processing. GPCs 208 communicate with memory interface 214 via crossbar unit 210 to read from or write to various DRAMs 220. In one embodiment, crossbar unit 210 has a connection to I/O unit 205, in addition to a connection to PP memory 204 via memory interface 214, thereby enabling the processing cores within the different GPCs 208 to communicate with system memory 104 or other memory not local to PPU 202. In the embodiment of FIG. 2, crossbar unit 210 is directly connected with I/O unit 205. In various embodiments, crossbar unit 210 may use virtual channels to separate traffic streams between the GPCs 208 and partition units 215.

Again, GPCs 208 can be programmed to execute processing tasks relating to a wide variety of applications, including, without limitation, linear and nonlinear data transforms, filtering of video and/or audio data, modeling operations (e.g., applying laws of physics to determine position, velocity and other attributes of objects), image rendering operations (e.g., tessellation shader, vertex shader, geometry shader, and/or pixel/fragment shader programs), general compute operations, etc. In operation, PPU 202 is configured to transfer data from system memory 104 and/or PP memory 204 to one or more on-chip memory units, process the data, and write result data back to system memory 104 and/or PP memory 204. The result data may then be accessed by other system components, including CPU 102, another PPU 202 within parallel processing subsystem 112, or another parallel processing subsystem 112 within computer system 100.

As noted above, any number of PPUs 202 may be included in a parallel processing subsystem 112. For example, multiple PPUs 202 may be provided on a single add-in card, or multiple add-in cards may be connected to communication path 113, or one or more of PPUs 202 may be integrated into a bridge chip. PPUs 202 in a multi-PPU system may be identical to or different from one another. For example, different PPUs 202 might have different numbers of processing cores and/or different amounts of PP memory 204. In implementations where multiple PPUs 202 are present, those PPUs may be operated in parallel to process data at a higher throughput than is possible with a single PPU 202. Systems incorporating one or more PPUs 202 may be implemented in a variety of configurations and form factors, including, without limitation, desktops, laptops, handheld personal computers or other handheld devices, servers, workstations, game consoles, embedded systems, and the like.

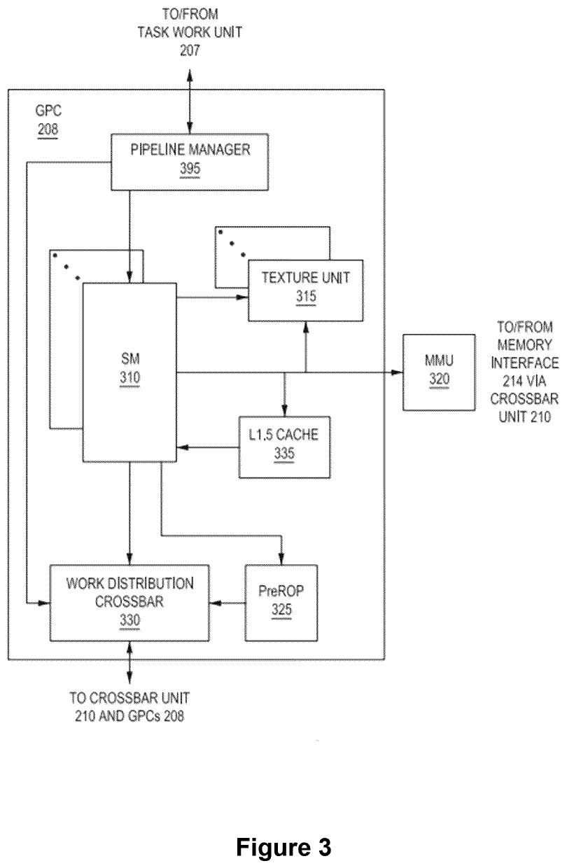

FIG. 3 is a block diagram of a GPC 208 included in PPU 202 of FIG. 2, according to various embodiments of the present disclosure. In operation, GPC 208 may be configured to execute a large number of threads in parallel to perform graphics, general processing and/or compute operations. As used herein, a “thread” refers to an instance of a particular program executing on a particular set of input data. In some embodiments, single-instruction, multiple-data (SIMD) instruction issue techniques are used to support parallel execution of a large number of threads without providing multiple independent instruction units. In other embodiments, single-instruction, multiple-thread (SIMT) techniques are used to support parallel execution of a large number of generally synchronized threads, using a common instruction unit configured to issue instructions to a set of processing engines within GPC 208. Unlike a SIMD execution regime, where all processing engines typically execute identical instructions, SIMT execution allows different threads to more readily follow divergent execution paths through a given program. Persons of ordinary skill in the art will understand that a SIMD processing regime represents a functional subset of a SIMT processing regime.

Operation of GPC 208 is controlled via a pipeline manager 305 that distributes processing tasks received from a work distribution unit (not shown) within task/work unit 207 to one or more streaming multiprocessors (SMs) 310. Pipeline manager 305 may also be configured to control a work distribution crossbar 330 by specifying destinations for processed data output by SMs 310.

In one embodiment, GPC 208 includes a set of M of SMs 310, where M≥1. Also, each SM 310 includes a set of functional execution units (not shown), such as execution units and load-store units. Processing operations specific to any of the functional execution units may be pipelined, which enables a new instruction to be issued for execution before a previous instruction has completed execution. Any combination of functional execution units within a given SM 310 may be provided. In various embodiments, the functional execution units may be configured to support a variety of different operations including integer and floating point arithmetic (e.g., addition and multiplication), comparison operations, Boolean operations (AND, OR, XOR), bit-shifting, and computation of various algebraic functions (e.g., planar interpolation and trigonometric, exponential, and logarithmic functions, etc.). Advantageously, the same functional execution unit can be configured to perform different operations.

In operation, each SM 310 is configured to process one or more thread groups. As used herein, a “thread group” or “warp” refers to a group of threads concurrently executing the same program on different input data, with one thread of the group being assigned to a different execution unit within an SM 310. A thread group may include fewer threads than the number of execution units within the SM 310, in which case some of the execution may be idle during cycles when that thread group is being processed. A thread group may also include more threads than the number of execution units within the SM 310, in which case processing may occur over consecutive clock cycles. Since each SM 310 can support up to G thread groups concurrently, it follows that up to G*M thread groups can be executing in GPC 208 at any given time.

Additionally, a plurality of related thread groups may be active (in different phases of execution) at the same time within an SM 310. This collection of thread groups is referred to herein as a “cooperative thread array” (“CTA”) or “thread array.” The size of a particular CTA is equal to m*k, where k is the number of concurrently executing threads in a thread group, which is typically an integer multiple of the number of execution units within the SM 310, and m is the number of thread groups simultaneously active within the SM 310.

Although not shown in FIG. 3, each SM 310 contains a level one (L1) cache or uses space in a corresponding L1 cache outside of the SM 310 to support, among other things, load and store operations performed by the execution units. Each SM 310 also has access to level two (L2) caches (not shown) that are shared among all GPCs 208 in PPU 202. The L2 caches may be used to transfer data between threads. Finally, SMs 310 also have access to off-chip “global” memory, which may include PP memory 204 and/or system memory 104. It is to be understood that any memory external to PPU 202 may be used as global memory. Additionally, as shown in FIG. 3, a level one-point-five (L1.5) cache 335 may be included within GPC 208 and configured to receive and hold data requested from memory via memory interface 214 by SM 310. Such data may include, without limitation, instructions, uniform data, and constant data. In embodiments having multiple SMs 310 within GPC 208, the SMs 310 may beneficially share common instructions and data cached in L1.5 cache 335.

Each GPC 208 may have an associated memory management unit (MMU) 320 that is configured to map virtual addresses into physical addresses. In various embodiments, MMU 320 may reside either within GPC 208 or within the memory interface 214. The MMU 320 includes a set of page table entries (PTEs) used to map a virtual address to a physical address of a tile or memory page and optionally a cache line index. The MMU 320 may include address translation lookaside buffers (TLB) or caches that may reside within SMs 310, within one or more L1 caches, or within GPC 208.

In graphics and compute applications, GPC 208 may be configured such that each SM 310 is coupled to a texture unit 315 for performing texture mapping operations, such as determining texture sample positions, reading texture data, and filtering texture data.

In operation, each SM 310 transmits a processed task to work distribution crossbar 330 in order to provide the processed task to another GPC 208 for further processing or to store the processed task in an L2 cache (not shown), parallel processing memory 204, or system memory 104 via crossbar unit 210. In addition, a pre-raster operations (preROP) unit 325 is configured to receive data from SM 310, direct data to one or more raster operations (ROP) units within partition units 215, perform optimizations for color blending, organize pixel color data, and perform address translations.

It will be appreciated that the core architecture described herein is illustrative and that variations and modifications are possible. Among other things, any number of processing units, such as SMs 310, texture units 315, or preROP units 325, may be included within GPC 208. Further, as described above in conjunction with FIG. 2, PPU 202 may include any number of GPCs 208 that are configured to be functionally similar to one another so that execution behavior does not depend on which GPC 208 receives a particular processing task. Further, each GPC 208 operates independently of the other GPCs 208 in PPU 202 to execute tasks for one or more application programs. In view of the foregoing, persons of ordinary skill in the art will appreciate that the architecture described in FIGS. 1-3 in no way limits the scope of the present disclosure.

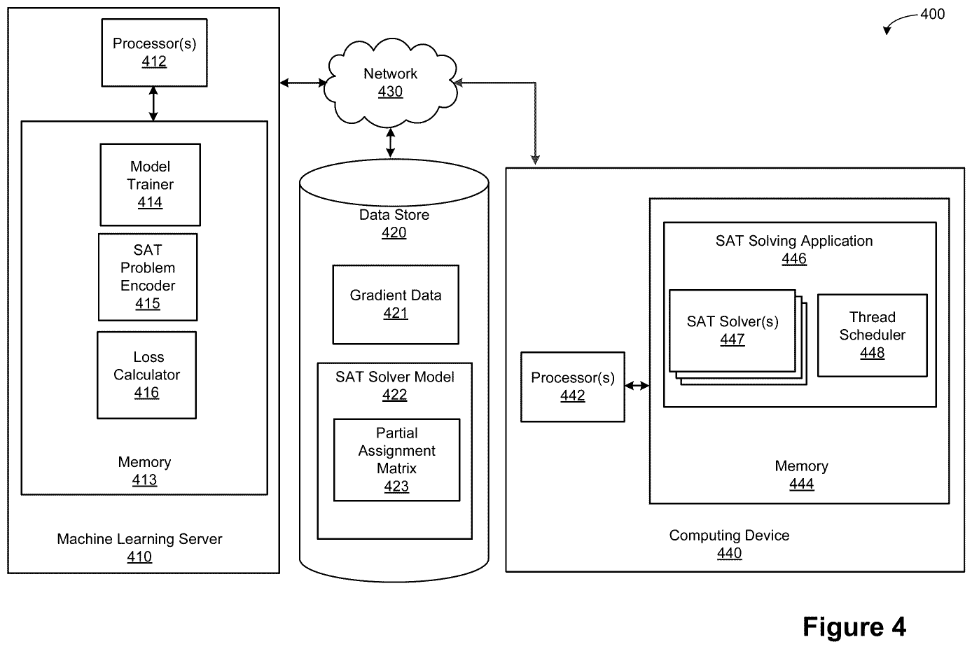

FIG. 4 is a block diagram of a computer system 400 configured to implement one or more aspects of various embodiments. As shown, system 400 includes, without limitation, a machine learning server 410, a data store 420, and a computing device 440 in communication over a network 430, which can be a wide area network (WAN) such as the Internet, a local area network (LAN), a cellular network, and/or any other suitable network. Machine learning server 410 includes, without limitation, processor(s) 412 and a memory 413. Memory 413 includes, without limitation, a model trainer 414, a SAT problem encoder 415, and a loss calculator 416. Data store 420 includes, without limitation, gradient data 421 and a SAT solver model 422. SAT solver model 422 includes, without limitation, a partial assignment matrix 423. Computing device 440 includes, without limitation, processor(s) 442 and a memory 444. Memory 444 includes, without limitation, a SAT solving application 446. SAT solving application 446 includes, without limitation, a thread manager 448 and one or more SAT solver(s) 447.

Processor(s) 412 receive user input from input devices, such as a keyboard or a mouse. Processor(s) 412 may include one or more primary processors of machine learning server 410, controlling and coordinating operations of other system components. In particular, processor(s) 412 can issue commands that control the operation of one or more graphics processing units (GPUs) (not shown) and/or other parallel processing circuitry (e.g., parallel processing units, deep learning accelerators, etc.) that incorporates circuitry optimized for graphics and video processing, including, for example, video output circuitry. The GPU(s) can deliver pixels to a display device that can be any conventional cathode ray tube, liquid crystal display, light-emitting diode display, and/or the like.

Memory 413 of machine learning server 410 stores content, such as software applications and data, for use by processor(s) 412 and the GPU(s) and/or other processing units. Memory 413 can be any type of memory capable of storing data and software applications, such as a random-access memory (RAM), a read-only memory (ROM), an erasable programmable read-only memory (EPROM or Flash ROM), or any suitable combination of the foregoing. In some embodiments, a storage (not shown) can supplement or replace memory 413. The storage can include any number and type of external memories that are accessible to processor 412 and/or the GPU. For example, and without limitation, the storage can include a Secure Digital Card, an external Flash memory, a portable compact disc read-only memory (CD-ROM), an optical storage device, a magnetic storage device, and/or any suitable combination of the foregoing.

Machine learning server 410 shown herein is for illustrative purposes only, and variations and modifications are possible without departing from the scope of the present disclosure. For example, the number of processors 412, the number of GPUs and/or other processing unit types, the number of system memories 414, and/or the number of applications included in memory 413 can be modified as desired. Further, the connection topology between the various units in FIG. 4 can be modified as desired. In some embodiments, any combination of processor(s) 412, memory 413, and/or GPU(s) can be included in and/or replaced with any type of virtual computing system, distributed computing system, and/or cloud computing environment, such as a public, private, or a hybrid cloud system.

As shown, SAT problem encoder 415 executes on one or more processors 412 of machine learning server 410 and is stored in memory 413 of machine learning server 410. In various embodiments, SAT problem encoder 415 is an application that processes a SAT problem and generates a SAT problem matrix. In some embodiments, the SAT problem includes determining whether there exists an assignment of true or false values to a set of Boolean variables such that a given logical formula evaluates to true. In some embodiments, the SAT problem is expressed in conjunctive normal form (CNF). A CNF formula is a conjunction of one or more clauses, where each clause is a disjunction of one or more literals, and each literal is a variable or the negation of that variable. In some embodiments, SAT problem encoder 415 receives the SAT problem in the standard Discrete Mathematics and Theoretical Computer Science (DIMACS) CNF format, parses the SAT problem clauses and variables, and generates a matrix representation of the SAT problem. In some embodiments, SAT problem encoder 415 generates a binary matrix included in the SAT problem matrix in which each row represents a clause, and each column represents a variable, with the entries indicating whether a variable appears positively, negatively, or not at all in a given clause.

Loss calculator 416 executes on one or more processors 412 of machine learning server 410 and is stored in memory 413 of machine learning server 410. Loss calculator 416 is an application that processes a satisfiability matrix and generates a loss. In some embodiments, the satisfiability matrix encodes variable assignments and the clause-level implications for a given SAT problem. In some embodiments, loss calculator 416 evaluates how well a predicted partial assignment matrix, such as partial assignment matrix 423, satisfies the clauses in the SAT problem, using one or more loss functions that quantify constraint violations. For example, the loss can be computed as the number or fraction of unsatisfied clauses given the predicted partial assignment matrix. In some examples, the loss is calculated based on a differentiable approximation of clause satisfaction to permit gradient-based training. In some embodiments, loss calculator 416 calculates weighted losses to emphasize harder clauses or prioritize certain types of violations and includes regularization terms that penalize unstable or ambiguous partial assignment matrices.

As shown, model trainer 414 is an application that executes on the one or more processors 412 of machine learning server 410 and is stored in a system memory 413 of machine learning server 410. Although shown as distinct from SAT problem encoder 415 and loss calculator 416 for illustrative purposes, in some embodiments, functionality of SAT problem encoder 415, loss calculator 416, and model trainer 414 can be combined into a single application.

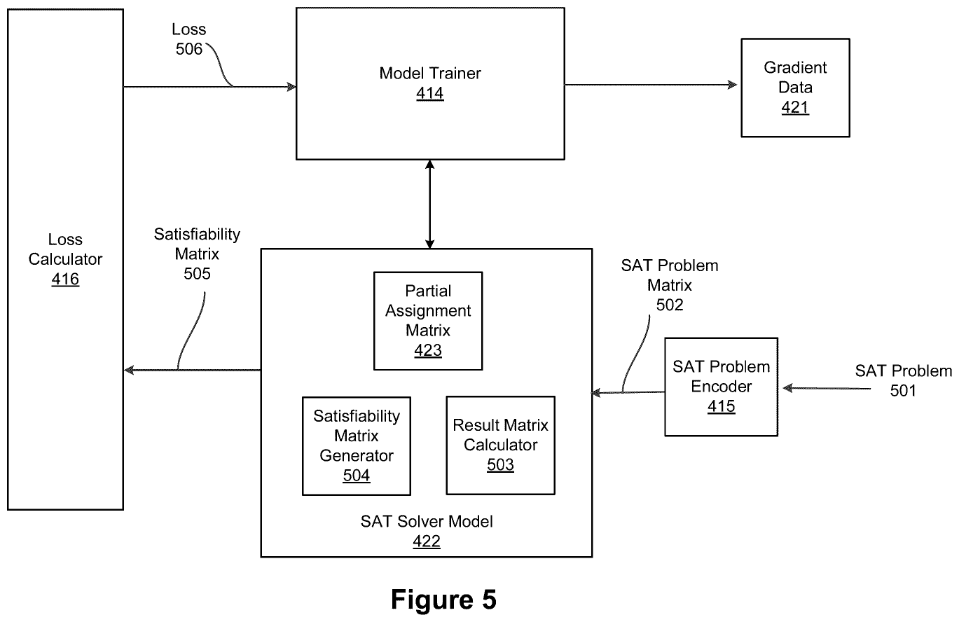

In some embodiments, model trainer 414 is configured to train one or more machine learning models, including SAT solver model 422. SAT solver model 422 is a machine learning model, such as a binary neural network, which processes the SAT problem matrix and generates the satisfiability matrix. In some embodiments, SAT solver model 422 includes a partial assignment matrix 423, a result matrix calculator, and a satisfiability matrix generator. In some embodiments, the result matrix calculator processes partial assignment matrix 423 and the SAT problem matrix and calculates a result matrix. In some embodiments, the result matrix calculator calculates the result matrix by performing a matrix multiplication of the SAT problem matrix by the partial assignment matrix. The satisfiability matrix generator processes the result matrix and generates the satisfiability matrix. During training, model trainer 414 uses the loss to iteratively update partial assignment matrix 423 until one or more stopping criteria are met. In some embodiments, model trainer 414 uses the loss to compute one or more gradients during training. Once the training stops, model trainer 414 stores the one or more gradients in gradient data 421 and stores SAT solver model 422 and gradient data 421 in data store 420 or elsewhere. In some embodiments, data store 420 includes any storage device or devices, such as fixed disc drive(s), flash drive(s), optical storage, network attached storage (NAS), and/or a storage area-network (SAN). Although shown as accessible over network 430, in at least one embodiment machine learning server 410 can include data store 420. Model trainer 414 is described in greater detail in conjunction with FIGS. 5, 8, and 9.

Computing device 440 shown herein is for illustrative purposes only, and variations and modifications in the design and arrangement of computing device 440, without departing from the scope of the present disclosure. For example, the number of processors 442, the number of and/or type of memories 444, and/or the number of applications and/or data stored in memory 444 can be modified as desired. In some embodiments, any combination of processor(s) 442 and/or memory 444 can be included in and/or replaced with any type of virtual computing system, distributed computing system, and/or cloud computing environment, such as a public, private, or a hybrid cloud system.

Each of processor(s) 442 can be any suitable processor, such as a CPU, a GPU, an ASIC, an FPGA, a DSP, a multicore processor, and/or any other type of processing unit, or a combination of two or more of a same type and/or different types of processing units, such as a SoC, or a CPU configured to operate in conjunction with a GPU. In general, processors 442 can be any technically feasible hardware unit capable of processing data and/or executing software applications. During operation, processor(s) 442 can receive user input from input devices (not shown), such as a keyboard or a mouse.

Memory 444 of computing device 440 stores content, such as software applications and data, for use by processor(s) 442. As shown, memory 444 includes, without limitation, SAT solving application 446. Memory 444 can be any type of memory capable of storing data and software applications, such as a RAM, a ROM, an EPROM or a Flash ROM, or any suitable combination of the foregoing. In some embodiments, additional storage (not shown) can supplement or replace memory 444. The storage can include any number and type of external memories that are accessible to processor(s) 442. For example, and without limitation, the storage can include a Secure Digital Card, an external Flash memory, a portable CD-ROM, an optical storage device, a magnetic storage device, and/or any suitable combination of the foregoing.

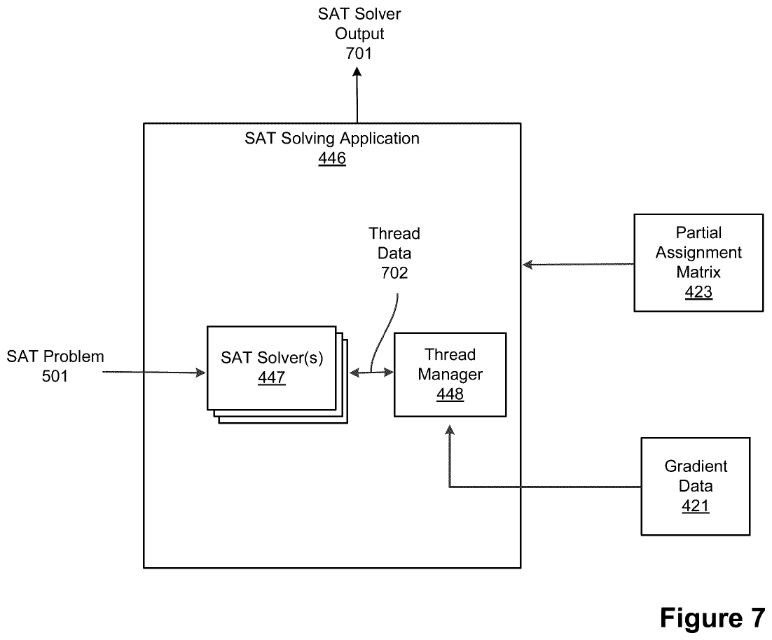

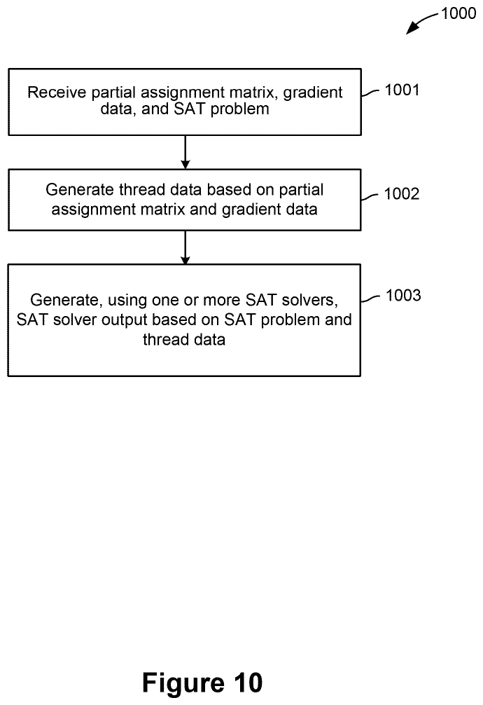

As shown, SAT solving application 446 is stored in memory 444 and executes on processor(s) 442. SAT solving application 446 uses partial assignment matrix 423 and gradient data 421 to process the SAT problem and generate a SAT solver output. In various embodiments, the SAT solver output includes a satisfiability result indicating whether SAT solving application 446 has found a satisfying assignment for the SAT problem. Whenever a satisfying assignment is found, the SAT solver output includes an assignment matrix that specifies a full set of Boolean variable assignments which satisfy all clauses of the input formula included in the SAT problem. SAT solving application 446 includes, without limitation, thread manager 448 and one or more SAT solver(s) 447. Thread manager 448 is an application that processes partial assignment matrix 423 and gradient data 421 and generates a thread data. In some embodiments, thread manager 448 assigns different solver threads to explore distinct branches of the solution space seeded from variations of the partial assignment matrix 423. In some embodiments, thread manager 448 uses gradient data 421 to prioritize certain variable assignments. The thread data includes the number of threads to launch, the assigned starting points in the variable space, and any diversification strategies to apply, such as randomized polarity, variable ordering, restart intervals, and/or the like. SAT solving application 446 uses one or more SAT solvers 447 to process the SAT problem based on the thread data and generate the SAT solver output. SAT solving application 446 is described in greater detail in conjunction with FIGS. 7 and 10.

FIG. 5 is a more detailed illustration of model trainer 414 training SAT solver model 422, according to various embodiments. As shown, SAT solver model 422 includes, without limitation, partial assignment matrix 423, result matrix calculator 503, and satisfiability matrix generator 504. In operation, SAT problem encoder 415 processes SAT problem 501 and generates SAT problem matrix 502. Result matrix calculator 503 performs a matrix multiplication based on SAT problem matrix 502 and partial assignment matrix 423 and calculates a result matrix. Satisfiability matrix generator 504 processes the result matrix and generates satisfiability matrix 505. Loss calculator 416 calculates loss 506 based on satisfiability matrix 505. Model trainer 414 uses loss 506 to iteratively update partial assignment matrix 423 until one or more stopping criteria are met. Once the training stops, model trainer 414 generates gradient data 421. In some embodiments, the disclosed techniques for solving SAT problems include a GPU-CPU hybrid solving system. The hybrid solving system synergistically combines GPU-driven differentiable optimization with CPU-based combinatorial search. The GPU-driven differentiable optimization is described in conjunction with FIGS. 5, and 8-9. The CPU-based combinatorial search is described in conjunction with FIGS. 7 and 10.

SAT problem encoder 415 processes SAT problem 501 and generates SAT problem matrix 502. In some embodiments, SAT problem encoder 415 receives SAT problem 501 in the standard DIMACS CNF format, parses the set of clauses and variables included in SAT problem 501, and generates a matrix representation P∈{0,1}^{C×2V}, where C is the number of clauses and V is the number of Boolean variables included in SAT problem 501. In some embodiments, each row of SAT problem matrix 502 corresponds to a clause, and each column corresponds to a literal, which includes either a variable xᵢ or the negation of the variable ¬xᵢ. In some embodiments, SAT problem matrix 502 includes only binary values: a value of 1 in entry [symbol] indicates that literal [symbol] is present in clause c, while a value of 0 indicates that the literal is absent. Thus, for each variable xᵢ, there are two corresponding columns in P:one for the positive literal xᵢ, and one for the negative literal ¬xᵢ. In some embodiments, SAT problem matrix 502 includes a more compact representation using entries in {−1,0,1} and a matrix of size C×V.

SAT solver model 422 processes SAT problem matrix 502 and generates satisfiability matrix 505. SAT solver model 422 includes partial assignment matrix 423, result matrix calculator 503, and satisfiability matrix generator 504. Partial assignment matrix 423 belongs to {0,1}^{2V×N}, where each column of A represents one candidate assignment to the variables included in SAT problem 501, and N is the number of parallel assignments being evaluated. In some embodiments, partial assignment matrix 423 includes a real-valued matrix Aᵣₑₐₗ∈ [symbol] ^{2V×N} in place of the binary matrix A, where each real-valued entry is subsequently binarized using a thresholding or sign function during evaluation. In some embodiments, SAT solver model 422 includes a binarization function B(x) that clamps all positive values to 1 and all non-positive values to 0 and is used to binarized real-valued partial assignment matrix 423 Aᵣₑₐₗ into matrix A∈{0,1}^{2V×N}. In the binary matrix A, a value of 1 indicates that the corresponding literal is assigned true, and a value of 0 indicates that the literal is assigned false. Partial assignment matrix 423 includes 2 rows per variable-one for each literal, xᵢ and the negation of the literal ¬xᵢ. For a complete assignment, every variable has exactly one of the two corresponding entries set to 1 and the other set to 0. In contrast, in an incomplete or relaxed assignment, both entries could be 0 or both could be 1. Whenever both are 1, the variable is treated as a “don't care” and is considered satisfied in any clause in which the variable appears. Whenever both are 0, the variable does not contribute to satisfying any clauses. In some embodiments, SAT solver model 422 performs rapid exploration of the assignment space through massively parallel matrix operations to evaluate one or more partial assignment matrices 423 simultaneously using one or more GPUs.

Result matrix calculator 503 processes SAT problem matrix 502 and partial assignment matrix 423 and calculates the result matrix. In some embodiments, result matrix calculator 503 performs a matrix multiplication R=PA, where

$$R ∈ {ℤ}_{\geq 0}^{C \times N}$$

is the result matrix. Each entry R_{c,n} in the result matrix indicates the number of satisfied literals in clause c under assignment n. In some embodiments, SAT problem matrix 502 P and partial assignment matrix 423 A are encoded in binary form to enable efficient computation using low-precision Tensor Core units on GPU hardware. In some embodiments, results matrix calculator 503 uses GPU-accelerated General Matrix Multiplication (GEMM) to perform the matrix multiplication.

Satisfiability matrix generator 504 processes the result matrix and generates satisfiability matrix 505. In some embodiments, satisfiability matrix 505 is computed by applying a column-wise minimum operation to the result matrix R. The resulting satisfiability matrix 505

$$S ∈ {ℤ}_{\geq 0}^{1 \times N}$$

includes one entry per assignment, where each entry Sₙ represents the minimum number of satisfied literals in any clause under assignment n. A satisfiability score Sₙ>0 indicates that assignment n satisfies at least one literal in every clause and is therefore a satisfying assignment for SAT problem 501. When Sₙ=0, there exists at least one clause for which assignment n satisfies no literals, and that assignment is unsatisfying. The maximum value across all entries in S indicates whether at least one satisfying assignment has been discovered among the N attempted assignments. If all values in S are zero, the satisfiability status of SAT problem 501 is indeterminate, as no satisfying assignment was found within the attempted set, though SAT problem 501 could still be satisfiable.

Loss calculator 416 processes satisfiability matrix 505 and calculates loss 506. In some embodiments, loss calculator 416 calculates loss 506 such that at least one candidate assignment satisfies all clauses of SAT problem 501, which corresponds to ensuring that satisfiability matrix 505, denoted S∈ [symbol] ^{1×N}, includes at least one nonzero entry. In some examples, loss 506 [symbol] is computed as the negative sum over all entries of satisfiability matrix 505:

$$ℒ = - {\sum }_{i = 1}^{N} {S}_{i} , \qquad ( Equation 1 )$$

where each Sᵢ represents the satisfiability score of assignment i, derived from the result matrix

$$R ∈ {ℤ}_{\geq 0}^{C \times N} .$$

In some embodiments, because the per-column minimum used to compute S from R is non-differentiable, loss calculator 416 applies a differentiable smooth minimum approximation, such as:

$${S}_{i} = Smooth Min ( {R}_{i} ) = \frac{{\sum }_{j = 1}^{C} {R}_{ij} {e}^{- τ {R}_{ij}}}{{\sum }_{j = 1}^{C} {e}^{- τ {R}_{ij}}} , \qquad ( Equation 2 )$$

where τ is a temperature parameter, and Rᵢ is the i-th column of the result matrix. The smooth minimum function as described in Equation 2 converges to the true minimum as τ→∞, enabling gradient-based optimization through backpropagation.

Model trainer 414 uses loss 506 to iteratively update partial assignment matrix 423 and generate gradient data 421. In some embodiments, model trainer 414 performs gradient-based optimization on a real-valued partial assignment matrix 423 Aᵣₑₐₗ. In some embodiments, model trainer 414 computes gradients from loss 506 and propagated through differentiable operations, such as using a straight-through estimator (STE). In some embodiments, model trainer 414 uses various optimization algorithms, such as a weighted adaptive moment estimation (AdamW) optimizer with a fixed initial learning rate (e.g., 10⁻¹) and a fixed minimum learning rate (e.g., 10⁻¹²). In some embodiments, model trainer 414 decays the learning rate by a fixed factor (e.g., 10) every fixed number of iterations (e.g., 30) to shift from aggressive early-stage exploration to fine-grained late-stage tuning. In some embodiments, model trainer 414 performs a learning rate restart every fixed number of iterations (e.g., 360), resetting the learning rate to the fixed initial learning rate to escape local minima and encourage exploration of new assignment regions. In some embodiments, to improve convergence and training stability, model trainer 414 applies per-variable normalization to the real-valued partial assignment matrix 423 Aᵣₑₐₗ. In some examples, for each row j in Aᵣₑₐₗ the mean μⱼ across all N assignments is computed as:

$${μ}_{j} = \frac{1}{N} {\sum }_{i = 1}^{N} {A}_{real , ij} . \qquad ( Equation 3 )$$

Then, each entry in the row is normalized by dividing the mean:

$${A}_{real , ij}^{norm} = \frac{{A}_{real , ij}}{{μ}_{j}} . \qquad ( Equation 4 )$$

The normalization operation improves gradient propagation and balances variable scales across the population of assignments. The normalized matrix

$${A}_{real , ij}^{norm}$$

is then binarized using a threshold function B(x), which maps positive values to 1 and non-positive values to 0, resulting in the binary assignment matrix A∈{0,1}^{2V×N}. Although binarization is a non-differentiable operation, model trainer 414 uses a STE to approximate the gradients of the threshold function, treating

$$\frac{\partial A}{\partial {A}_{real}^{norm}}$$

as the identity matrix during backpropagation. In some embodiments, at each learning rate restart, model trainer 414 performs per-assignment weight mixing to improve convergence and enable knowledge transfer between high-performing and low-performing candidate assignments. In some embodiments, model trainer 414 identifies the best-performing assignment

$${A}_{i}^{*}$$

(e.g., the assignment satisfying the most clauses), and averages the corresponding weights into all other assignments, such as:

$${A}_{real , i}^{m i x e d} = \frac{1}{2} ( {A}_{real , i} + {A}_{real , {i}^{*}} ) . \qquad ( Equation 5 )$$

The mixing strategy as described in Equation 5 permits guiding the optimization toward better optima by initializing each new iteration with blended solutions that combine successful patterns across candidates. In some embodiments, model trainer 414 continues training until one or more stopping criteria are met. Stopping criteria include but are not limited to reaching a maximum number of training iterations, detecting convergence in loss 506 (e.g., the loss does not decrease beyond a small threshold over several consecutive steps), and finding a satisfying assignment (e.g., when at least one column of satisfiability matrix 505 has a nonzero value, indicating that all clauses have been satisfied under at least one candidate assignment). Once the training stops, model trainer 414 generates gradient data 421 and stores gradient data 421 and SAT solver model 422 in datastore 420 or elsewhere. Gradient data 421 includes but is not limited to the final gradient values computed with respect to the real-valued partial assignment matrix 423 Aᵣₑₐₗ. Gradient data 421 reflects the sensitivity of loss 506 to changes in each literal assignment across the candidate solutions. In some embodiments, gradient data 421 includes historical gradient statistics, such as moving averages, momentum values, and/or the like.

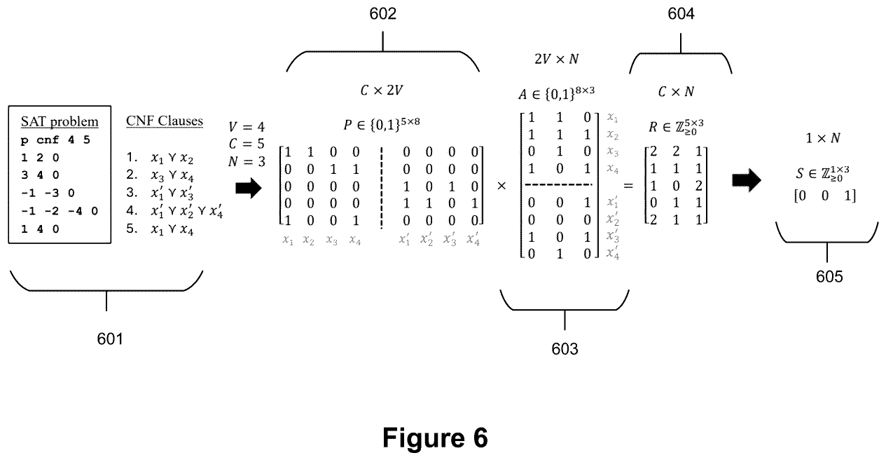

FIG. 6 is a simplified depiction of the matrix computations performed by the SAT solver model of FIG. 4, according to various embodiments. As shown, SAT problem 601, which is an example of SAT problem 501, is received in CNF format and encoded into clauses. SAT problem 601 includes V=4 variables, C=5 clauses, and N=3 candidate assignments. SAT problem encoder 415 processes SAT problem 601 and generates SAT problem matrix 602 P∈{0,1}^{C×2V}, which is an example of SAT problem matrix 502. Each row of SAT problem matrix 602 encodes the literals present in a clause. The columns correspond to both positive and negated forms of the variables (x₁, x₂, x₃, x₄, ¬x₁, ¬x₂, ¬x₃, ¬x₄) included in SAT problem 601. Partial assignment matrix 603, which is an example of partial assignment matrix 423, belongs to {0,1}^{2V×N} with each column representing a candidate assignment of truth values to all literals. A value of 1 in row i, column j of partial assignment matrix 502 A indicates that the i-th literal is assigned True in the j-th assignment. Result matrix calculator 503 performs a matrix multiplication R=PA, and generates result matrix 604

$$R ∈ {ℤ}_{\geq 0}^{C \times N} ,$$

where each entry R_{c,n} indicates how many literals in clause c are satisfied by assignment n. Satisfiability matrix generator 504 processes result matrix 604 and generates satisfiability matrix 605

$$S ∈ {ℤ}_{\geq 0}^{1 \times N} ,$$

which is an example of satisfiability matrix 505, by taking the column-wise minimum across each column of R, so that Sₙ=min_{c}R_{c,n}. If Sₙ>0, assignment n satisfies all clauses in SAT problem 601. In the example shown, only the third candidate assignment yields S₃=1, indicating the third candidate assignment is a satisfying assignment.

FIG. 7 is a more detailed illustration of SAT solving application 446, according to various embodiments. As shown, SAT solving application 446 includes, without limitation, thread manager 448 and one or more SAT solvers 447. Thread manager 448 processes partial assignment matrix 423 and gradient data 421 and generates thread data 702. SAT solving application 446 uses one or more SAT solvers 447 to process SAT problem 501 based on thread data 702 and partial assignment matrix 423 and generate SAT solver output 701.

SAT solving application 446 uses partial assignment matrix 423 and gradient data 421 to process SAT problem 501 and generate a SAT solver output 701. In some embodiments, thread manager 448 processes partial assignment matrix 423 and gradient data 421 and generates thread data 702. In some embodiments, thread manager 448 selects a subset of variable assignments from partial assignment matrix 423 to generate seed data for SAT solvers 447. In some embodiments, thread manager 448 extracts the truth values of the most confident variables, (e.g., the top 5% with the lowest gradient magnitudes across all candidate assignments included in partial assignment matrix 423). In some embodiments, thread manager 448 infers confidence in a candidate assignment included in partial assignment matrix 423 using the final gradient magnitudes included in gradient data 421, wherein smaller absolute gradient values indicate that the variable has stabilized and is less likely to change under further optimization by SAT solvers 447. Thread manager 448 uses the high-confidence variables and the associated truth values to generate partial assignments (e.g., seed data), which serve as initialization inputs included in thread data 702 to SAT solvers 447.

SAT solving application 446 uses one or more SAT solvers 447 to process SAT problem 501 based on thread data 702 and generate the SAT solver output 701. In some embodiments, SAT solving application 446 executes SAT solvers 447 across one or more CPU threads. Each SAT solver 447 receives a partial assignment (e.g., seed data) included in thread data 702 and proceeds to explore the remaining unfixed variables to search for a satisfying SAT solution. In some embodiments, SAT solvers 447 are conflict driven clause learning (CDCL) solvers, which apply unit propagation, clause learning, and non-chronological backtracking to resolve logical constraints. The use of partial assignments included in thread data 702 helps reduce the search space and accelerates solving time compared to unseeded or randomly initialized candidate assignments. In some embodiments, the number of launched CPU threads of SAT solvers 447 is based on available CPU cores or hardware threads. Whenever the number of candidate assignments N exceeds the available thread capacity, SAT solving application 446 prioritizes the partial assignments associated with higher clause satisfaction scores based on thread data 702. In some examples, partial assignments covering only a small fraction of the variables, such as 5%, can significantly improve the solver efficiency of SAT solving application 446. Fixing V* number of variables reduces the search space by a factor of 2^{V*}, guiding SAT solvers 447 toward high-likelihood solution regions. In some embodiments, the fixed variables also activate early-stage Boolean Constraint Propagation (BCP), enabling further deduction of variable assignments and compounding the SAT solving efficiency, which transforms SAT solver 447 from a cold-start configuration into a warm-started, guided search procedure. SAT solving application 446 generates SAT solver output 701 based on the outcome of the solver threads (e.g., SAT solvers 447). In some embodiments, SAT solver output 701 includes a satisfiability result indicating whether at least one satisfying assignment has been found. Whenever at least one satisfying assignment is found, SAT solver output 701 further includes a complete assignment of Boolean values to all variables in SAT problem 501. Whenever no satisfying assignment is found, SAT solver output 701 includes an indeterminate result. In some embodiments, SAT solver output 701 includes diagnostic or performance metadata, such as the index of the successful assignment, solving time, the number of variables resolved, and/or the like.

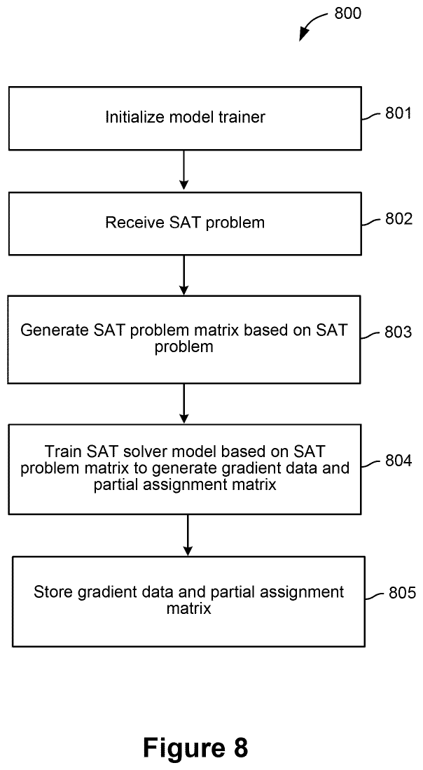

FIG. 8 is a flow diagram of method steps for generating gradient data and partial assignment matrix, according to various embodiments. Although the method steps are described in conjunction with the embodiments of FIGS. 1-7, persons skilled in the art will understand that any system configured to perform the method steps in any order falls within the scope of the present disclosure.

As shown, a method 800 begins with step 801, where model trainer 414 is initialized. In some embodiments, model trainer 414 initializes the initial learning rate (e.g., 10⁻¹), the minimum learning rate (e.g., 10⁻¹²), the learning rate decay factor (e.g., 10), and the decay interval (e.g., every 30 training iterations). In some embodiments, model trainer 414 initializes a learning rate restart interval (e.g., every 360 iterations) to reset the learning rate to the initial learning rate. In some embodiments, model trainer 414 further initializes the number of candidate assignments N (e.g., 128), which determines the number of columns in the real-valued partial assignment matrix 423. Model trainer 414 also initializes each entry of partial assignment matrix 423 by sampling from a standard normal distribution (e.g., [symbol] (0,1)). In some embodiments, model trainer 414 initializes the temperature parameter τ (e.g., τ=10) as described in Equation 2. In some embodiments, model trainer 414 initializes the parameters of AdamW optimizer. In some embodiments, model trainer 414 initializes one or more stopping criteria including but not limited to reaching a maximum number of iterations (e.g., 1000), loss convergence (e.g., loss improvement <10⁻⁴ over 10 steps), or finding a satisfying assignment (e.g., when one or more columns in satisfiability matrix 505 indicate all clauses are satisfied).

At step 802, SAT problem encoder 415 receives SAT problem 501. In some embodiments, SAT problem encoder 415 receives SAT problem 501 via one or more I/O devices. In some embodiments, SAT problem encoder 415 receives SAT problem 501 in the standard DIMACS CNF format.

At step 803, SAT problem encoder 415 generates SAT problem matrix 502 based on SAT problem 501. In some embodiments, SAT problem encoder 415 parses the set of clauses and variables included in SAT problem 501 and generates a matrix representation P∈{0,1}^{C×2V}.

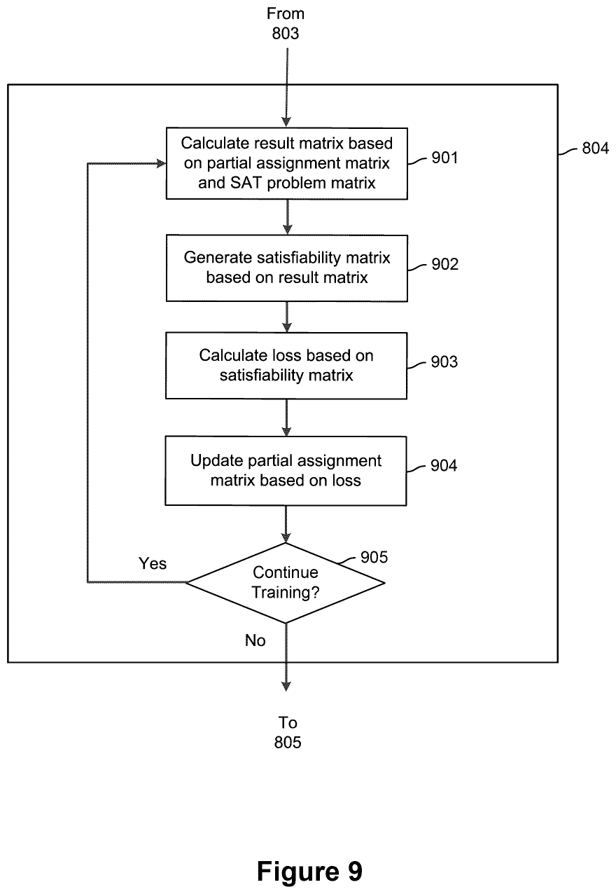

At step 804, model trainer 414 trains SAT solver model 422 based on SAT problem matrix 502 to generate gradient data 421 and partial assignment matrix 423. Result matrix calculator 503 performs a matrix multiplication based on SAT problem matrix 502 and partial assignment matrix 423 and calculates a result matrix. Satisfiability matrix generator 504 processes the result matrix and generates satisfiability matrix 505. Loss calculator 416 calculates loss 506 based on satisfiability matrix 505. Model trainer 414 uses loss 506 to iteratively update partial assignment matrix 423 until one or more stopping criteria are met. Once the training stops, model trainer 414 generates gradient data 421. In some embodiments, SAT solver model 422 performs rapid exploration of the assignment space through parallel matrix operations to evaluate one or more partial assignment matrices 423 simultaneously using one or more GPUs. Step 804 is described in greater detail in conjunction with FIG. 9.

At step 805, model trainer 414 stores gradient data 421 and partial assignment matrix 423. In some embodiments, model trainer 414 stores gradient data 421 and partial assignment matrix 423 in data store 420 or elsewhere.

FIG. 9 is a flow diagram of method steps for training a SAT solver model 422, according to various embodiments. Although the method steps are described in conjunction with the embodiments of FIGS. 1-7, persons skilled in the art will understand that any system configured to perform the method steps in any order falls within the scope of the present disclosure.

Step 804 of the method 800 begins with step 901, where result matrix calculator 503 calculates the result matrix based on partial assignment matrix 423 and SAT problem matrix 502. In some embodiments, result matrix calculator 503 performs a matrix multiplication. In some embodiments, SAT problem matrix 502 and partial assignment matrix 423 are encoded in binary form to enable efficient computation using low-precision Tensor Core units on GPU hardware. In some embodiments, results matrix calculator 503 uses GPU-accelerated GEMM to perform the matrix multiplication.

At step 902, satisfiability matrix generator 504 generates satisfiability matrix 505 based on the result matrix. In some embodiments, satisfiability matrix 505 is computed by applying a column-wise minimum operation to the result matrix.

At step 903, loss calculator 416 calculates loss 506 based on satisfiability matrix 505. In some embodiments, loss calculator 416 calculates loss 506 such that at least one candidate assignment satisfies all clauses of SAT problem 501, which corresponds to ensuring that satisfiability matrix 505 includes at least one nonzero entry. In some examples, loss 506 is computed as the negative sum over all entries of satisfiability matrix 505 as described in Equation 1. In some embodiments, because the per-column minimum used to compute satisfiability matrix 505 from the result matrix is non-differentiable, loss calculator 416 applies a differentiable smooth minimum approximation, for example, as described in Equation 2.

At step 904, model trainer 414 updates partial assignment matrix 423 based on loss 506. In some embodiments, model trainer 414 performs gradient-based optimization on a real-valued partial assignment matrix 423. In some embodiments, model trainer 414 computes gradients from loss 506 and propagated through differentiable operations, such as STE. In some embodiments, model trainer 414 uses various optimization algorithms, such as an AdamW optimizer with a fixed initial learning rate and a fixed minimum learning rate. In some embodiments, model trainer 414 decays the learning rate by a fixed factor every fixed number of iterations to shift from aggressive early-stage exploration to fine-grained late-stage tuning. In some embodiments, model trainer 414 performs a learning rate restart every fixed number of iterations, resetting the learning rate to the fixed initial learning rate to escape local minima and encourage exploration of new assignment regions. In some embodiments, to improve convergence and training stability, model trainer 414 applies per-variable normalization to the real-valued partial assignment matrix 423, for example, as descried in Equations 3 and 4. In some embodiments, the normalized partial assignment matrix 423 is then binarized using a threshold function to generate a binary partial assignment matrix 423. Although binarization is a non-differentiable operation, model trainer 414 uses the STE to approximate the gradients of the threshold function. In some embodiments, at each learning rate restart, model trainer 414 performs per-assignment weight mixing to improve convergence and enable knowledge transfer between high-performing and low-performing candidate assignments. In some embodiments, model trainer 414 identifies the best-performing assignment (e.g., the assignment satisfying the most clauses), and averages the corresponding weights into all other assignments, for example, as described in Equation 5.

At step 905, model trainer 414 determines whether to continue training. In some embodiments, model trainer 414 continues training until one or more stopping criteria are met. Stopping criteria include but are not limited to reaching a maximum number of training iterations, detecting convergence in loss 506 (e.g., loss 506 does not decrease beyond a small threshold over several consecutive steps), and finding a satisfying assignment (e.g., when at least one column of satisfiability matrix 505 has a nonzero value, indicating that all clauses have been satisfied under at least one candidate assignment). Whenever model trainer 414 determines to continue training, step 804 returns to step 901. Whenever model trainer 414 determines not to continue training, the method 800 proceeds to step 805.

FIG. 10 is a flow diagram of method steps for generating SAT solver output 701, according to various embodiments. Although the method steps are described in conjunction with the embodiments of FIGS. 1-7, persons skilled in the art will understand that any system configured to perform the method steps in any order falls within the scope of the present disclosure.

As shown, a method 1000 begins with step 1001, where SAT solving application 446 receives partial assignment matrix 423, gradient data 421, and SAT problem 501. In some embodiments, SAT solving application 446 receives SAT problem 501 via one or more I/O devices. In some embodiments, SAT solving application 446 receives partial assignment matrix 423 and gradient data 421 from data store 420 over network 430.

At step 1002, thread manager 448 generates thread data 702 based on partial assignment matrix 423 and gradient data 421. In some embodiments, thread manager 448 selects a subset of variable assignments from partial assignment matrix 423 to generate seed data for SAT solvers 447. In some embodiments, thread manager 448 extracts the truth values of the most confident variables, (e.g., the top 5% with the lowest gradient magnitudes across all candidate assignments included in partial assignment matrix 423). In some embodiments, thread manager 448 infers confidence in a candidate assignment included in partial assignment matrix 423 using the final gradient magnitudes included in gradient data 421, wherein smaller absolute gradient values indicate that the variable has stabilized and is less likely to change under further optimization by SAT solvers 447. Thread manager 448 uses the high-confidence variables and the associated truth values to generate partial assignments (e.g., seed data), which serve as initialization inputs included in thread data 702 to SAT solvers 447.

At step 1003, SAT solving application 446 generates, using one or more SAT solvers 447, SAT solver output 701 based on SAT problem 501 and thread data 702. In some embodiments, SAT solving application 446 executes SAT solvers 447 across one or more CPU threads. Each SAT solver 447 receives a partial assignment (e.g., seed data) included in thread data 702 and proceeds to explore the remaining unfixed variables to search for a satisfying SAT solution. In some embodiments, SAT solvers 447 are CDCL solvers, which apply unit propagation, clause learning, and non-chronological backtracking to resolve logical constraints. The use of partial assignments included in thread data 702 helps reduce the search space and accelerates solving time compared to unseeded or randomly initialized candidate assignments. In some embodiments, the number of launched CPU threads of SAT solvers 447 is based on available CPU cores or hardware threads. Whenever the number of candidate assignments N exceeds the available thread capacity, SAT solving application 446 prioritizes the partial assignments associated with higher clause satisfaction scores based on thread data 702. In some examples, partial assignments covering only a small fraction of the variables, such as 5%, can significantly improve the solver efficiency of SAT solving application 446. Fixing V* number of variables reduces the search space by a factor of 2^{V*}, guiding SAT solvers 447 toward high-likelihood solution regions. In some embodiments, the fixed variables also activate early-stage BCP, enabling further deduction of variable assignments and compounding the SAT solving efficiency, which transforms SAT solver 447 from a cold-start configuration into a warm-started, guided search procedure. SAT solving application 446 generates SAT solver output 701 based on the outcome of the solver threads (e.g., SAT solvers 447). In some embodiments, SAT solver output 701 includes a satisfiability result indicating whether at least one satisfying assignment has been found. Whenever at least one satisfying assignment is found, SAT solver output 701 further includes a complete assignment of Boolean values to all variables in SAT problem 501. Whenever no satisfying assignment is found, SAT solver output 701 includes an indeterminate result. In some embodiments, SAT solver output 701 includes diagnostic or performance metadata, such as the index of the successful assignment, solving time, the number of variables resolved, and/or the like.

In sum, techniques are disclosed for solving SAT problems using a GPU-CPU hybrid solving system. The hybrid solving system synergistically combines GPU-driven differentiable optimization with CPU-based combinatorial search. In some embodiments, a model trainer trains a SAT solver model to generate gradient data and a partial assignment matrix based on a SAT problem using GPU-driven differentiable optimization. During the training of the SAT solver, a SAT problem encoder processes the SAT problem and generates a SAT problem matrix. The SAT solver model includes, without limitation, the partial assignment matrix, a result matrix calculator, and a satisfiability matrix generator. The result matrix calculator performs a matrix multiplication based on the SAT problem matrix and the partial assignment matrix and calculates the result matrix, which in some embodiments is performed using one or more GPUs. The satisfiability matrix generator processes the result matrix and generates the satisfiability matrix. A loss calculator calculates a loss based on the satisfiability matrix. The model trainer uses the loss to iteratively update the partial assignment matrix until one or more stopping criteria is met. Once the training stops, the model trainer generates the gradient data and stores the gradient data and the partial assignment matrix. A SAT solving application processes the partial assignment matrix, the gradient data, and the SAT problem and generates a SAT solver output. The SAT solving application includes, without limitation, a thread manager and one or more SAT solvers. The thread manager processes the partial assignment matrix and the gradient data and generates a thread data. The SAT solving application uses the one or more SAT solvers to process the SAT problem based on the thread data and generate the SAT solver output, which in some embodiments include performing a combinatorial search on one or more CPU threads.

At least one technical advantage of the disclosed techniques relative to the prior art is that the disclosed techniques enable parallelized SAT solving by combining gradient-based training of candidate variable assignments with seeded initialization of multiple SAT solver threads. Instead of relying solely on the inherently sequential decision-making structure of conventional SAT solvers, such as conflict-driven clause learning (CDCL) algorithms, the disclosed techniques include training a real-valued partial assignment matrix using differentiable loss functions and gradient-based optimization, then uses the resulting high-confidence assignments to initialize multiple parallel SAT solver threads. The disclosed techniques decouple the exploration of promising solution regions from the sequential branching process included in conventional SAT solvers, enabling effective use of highly parallel architectures, such as graphics processing units (GPUs) during training and multithreaded central processing unit (CPU) execution during solving. These technical advantages provide one or more technological improvements over prior art approaches.
1. In some embodiments, a computer-implemented method for solving a Boolean satisfiability (SAT) problem comprises receiving a SAT problem, generating, based on the SAT problem, a SAT problem matrix, performing, based on the SAT problem matrix, one or more operations to train an untrained machine learning model to generate a trained machine learning model and gradient data, wherein the trained machine learning model comprises a trained partial assignment matrix, and generating, based on the trained partial assignment matrix and the gradient data and using one or more SAT solvers, a SAT solver output.
2. The computer-implemented method of clause 1, wherein the SAT problem is specified using conjunctive normal form.
3. The computer-implemented method of clauses 1 or 2, wherein performing the one or more operations to train the untrained machine learning model comprises calculating, based on the SAT problem matrix and an untrained partial assignment matrix included in the untrained machine learning model, a result matrix, generating, based on the result matrix, a satisfiability matrix, calculating, based on the satisfiability matrix, a loss, and updating, based on the loss, the untrained partial assignment matrix.
4. The computer-implemented method of any of clauses 1-3, wherein calculating the result matrix comprises performing a matrix multiplication of the SAT problem matrix by the untrained partial assignment matrix.
5. The computer-implemented method of any of clauses 1-4, wherein generating the satisfiability matrix comprises applying a column-wise minimum operation to the result matrix.
6. The computer-implemented method of any of clauses 1-5, wherein updating the untrained partial assignment matrix comprises generating, based on the untrained partial assignment matrix, a normalized partial assignment matrix, generating, based on the normalized partial assignment matrix, a binary partial assignment matrix using a binarization function, and performing a gradient-based optimization, based on the binary partial assignment matrix and using a straight-through estimator (STE), to generate one or more gradients.
7. The computer-implemented method of any of clauses 1-6, wherein calculating the loss comprises using a differentiable smooth minimum approximation of the satisfiability matrix.
8. The computer-implemented method of any of clauses 1-7, wherein updating the untrained partial assignment matrix further comprises identifying a best-performing assignment included in the untrained partial assignment matrix, and averaging the best-performing assignment and one or more other assignments included in the untrained partial assignment matrix.
9. The computer-implemented method of any of clauses 1-8, wherein generating the SAT solver output comprises generating, based on the trained partial assignment matrix and the gradient data, thread data, initializing, based on the thread data, the one or more SAT solvers, and generating, using the one or more SAT solvers, the solver output.
10. The computer-implemented method of any of clauses 1-9, wherein generating the thread data comprises selecting one or more partial assignments included in the partial assignment matrix having lowest gradient magnitudes.
11. The computer-implemented method of any of clauses 1-10, wherein the one or more SAT solvers comprise conflict-driven clause learning (CDCL) SAT solvers.
12. The computer-implemented method of any of clauses 1-11, wherein the SAT solver output comprises at least one of a satisfiability result and a variable assignment that satisfies the SAT problem.
13. In some embodiments, one or more non-transitory computer-readable media store instructions that, when executed by one or more processors, cause the one or more processors to perform the steps of receiving a Boolean satisfiability (SAT) problem, generating, based on the SAT problem, a SAT problem matrix, performing, based on the SAT problem matrix, one or more operations to train an untrained machine learning model to generate a trained machine learning model and gradient data, wherein the trained machine learning model comprises a trained partial assignment matrix, and generating, based on the trained partial assignment matrix and the gradient data and using one or more SAT solvers, a SAT solver output.
14. The one or more non-transitory computer-readable media of clause 13, wherein performing the one or more operations to train the untrained machine learning model comprises calculating, based on the SAT problem matrix and an untrained partial assignment matrix included in the untrained machine learning model, a result matrix, generating, based on the result matrix, a satisfiability matrix, calculating, based on the satisfiability matrix, a loss, and updating, based on the loss, the untrained partial assignment matrix.
15. The one or more non-transitory computer-readable media of clauses 13 or 14, wherein updating the untrained partial assignment matrix comprises generating, based on the untrained partial assignment matrix, a normalized partial assignment matrix, generating, based on the normalized partial assignment matrix, a binary partial assignment matrix using a binarization function, and performing a gradient-based optimization, based on the binary partial assignment matrix and using a STE, to generate one or more gradients.
16. The one or more non-transitory computer-readable media of any of clauses 13-15, wherein updating the untrained partial assignment matrix comprises decaying a learning rate by a fixed factor after a fixed number of one or more training iterations.
17. The one or more non-transitory computer-readable media of any of clauses 13-16, wherein updating the untrained partial assignment matrix comprises restarting a learning rate to an initial value after a fixed number of one or more training iterations.
18. The one or more non-transitory computer-readable media of any of clauses 13-17, wherein generating the SAT solver output comprises generating, based on the trained partial assignment matrix and the gradient data, thread data, initializing, based on the thread data, the one or more SAT solvers, and generating, using the one or more SAT solvers, the solver output.
19. The one or more non-transitory computer-readable media of any of clauses 13-18, wherein generating the thread data comprises selecting one or more partial assignments included in the partial assignment matrix having lowest gradient magnitudes.
20. In some embodiments, a system comprises one or more memories storing instructions, and one or more processors that are coupled to the one or more memories and, when executing the instructions, are configured to receive a Boolean satisfiability (SAT) problem, generate, based on the SAT problem, a SAT problem matrix, perform, based on the SAT problem matrix, one or more operations to train an untrained machine learning model to generate a trained machine learning model and gradient data, wherein the trained machine learning model comprises a trained partial assignment matrix, and generate, based on the trained partial assignment matrix and the gradient data and using one or more SAT solvers, a SAT solver output.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for solving a Boolean satisfiability (SAT) problem, the method comprising:
receiving a SAT problem;
generating, based on the SAT problem, a SAT problem matrix;
performing, based on the SAT problem matrix, one or more operations to train an untrained machine learning model to generate a trained machine learning model and gradient data, wherein the trained machine learning model comprises a trained partial assignment matrix; and
generating, based on the trained partial assignment matrix and the gradient data and using one or more SAT solvers, a SAT solver output.

2. The computer-implemented method of claim 1, wherein the SAT problem is specified using conjunctive normal form.

3. The computer-implemented method of claim 1, wherein performing the one or more operations to train the untrained machine learning model comprises:
calculating, based on the SAT problem matrix and an untrained partial assignment matrix included in the untrained machine learning model, a result matrix;
generating, based on the result matrix, a satisfiability matrix;
calculating, based on the satisfiability matrix, a loss; and
updating, based on the loss, the untrained partial assignment matrix.

4. The computer-implemented method of claim 3, wherein calculating the result matrix comprises performing a matrix multiplication of the SAT problem matrix by the untrained partial assignment matrix.

5. The computer-implemented method of claim 3, wherein generating the satisfiability matrix comprises applying a column-wise minimum operation to the result matrix.

6. The computer-implemented method of claim 3, wherein updating the untrained partial assignment matrix comprises:
generating, based on the untrained partial assignment matrix, a normalized partial assignment matrix;
generating, based on the normalized partial assignment matrix, a binary partial assignment matrix using a binarization function; and
performing a gradient-based optimization, based on the binary partial assignment matrix and using a straight-through estimator (STE), to generate one or more gradients.

7. The computer-implemented method of claim 3, wherein calculating the loss comprises using a differentiable smooth minimum approximation of the satisfiability matrix.

8. The computer-implemented method of claim 3, wherein updating the untrained partial assignment matrix further comprises:
identifying a best-performing assignment included in the untrained partial assignment matrix; and
averaging the best-performing assignment and one or more other assignments included in the untrained partial assignment matrix.

9. The computer-implemented method of claim 1, wherein generating the SAT solver output comprises:
generating, based on the trained partial assignment matrix and the gradient data, thread data;
initializing, based on the thread data, the one or more SAT solvers; and
generating, using the one or more SAT solvers, the solver output.

10. The computer-implemented method of claim 9, wherein generating the thread data comprises selecting one or more partial assignments included in the partial assignment matrix having lowest gradient magnitudes.

11. The computer-implemented method of claim 1, wherein the one or more SAT solvers comprise conflict-driven clause learning (CDCL) SAT solvers.

12. The computer-implemented method of claim 1, wherein the SAT solver output comprises at least one of a satisfiability result and a variable assignment that satisfies the SAT problem.

13. One or more non-transitory computer-readable media storing instructions that, when executed by one or more processors, cause the one or more processors to perform the steps of:
receiving a Boolean satisfiability (SAT) problem;
generating, based on the SAT problem, a SAT problem matrix;
performing, based on the SAT problem matrix, one or more operations to train an untrained machine learning model to generate a trained machine learning model and gradient data, wherein the trained machine learning model comprises a trained partial assignment matrix; and
generating, based on the trained partial assignment matrix and the gradient data and using one or more SAT solvers, a SAT solver output.

14. The one or more non-transitory computer-readable media of claim 13, wherein performing the one or more operations to train the untrained machine learning model comprises:
calculating, based on the SAT problem matrix and an untrained partial assignment matrix included in the untrained machine learning model, a result matrix;
generating, based on the result matrix, a satisfiability matrix;
calculating, based on the satisfiability matrix, a loss; and
updating, based on the loss, the untrained partial assignment matrix.

15. The one or more non-transitory computer-readable media of claim 14, wherein updating the untrained partial assignment matrix comprises:
generating, based on the untrained partial assignment matrix, a normalized partial assignment matrix;
generating, based on the normalized partial assignment matrix, a binary partial assignment matrix using a binarization function; and
performing a gradient-based optimization, based on the binary partial assignment matrix and using a STE, to generate one or more gradients.

16. The one or more non-transitory computer-readable media of claim 14, wherein updating the untrained partial assignment matrix comprises decaying a learning rate by a fixed factor after a fixed number of one or more training iterations.

17. The one or more non-transitory computer-readable media of claim 14, wherein updating the untrained partial assignment matrix comprises restarting a learning rate to an initial value after a fixed number of one or more training iterations.

18. The one or more non-transitory computer-readable media of claim 13, wherein generating the SAT solver output comprises:
generating, based on the trained partial assignment matrix and the gradient data, thread data;
initializing, based on the thread data, the one or more SAT solvers; and
generating, using the one or more SAT solvers, the solver output.

19. The one or more non-transitory computer-readable media of claim 18, wherein generating the thread data comprises selecting one or more partial assignments included in the partial assignment matrix having lowest gradient magnitudes.

20. A system, comprising:
one or more memories storing instructions, and
one or more processors that are coupled to the one or more memories and, when executing the instructions, are configured to:
receive a Boolean satisfiability (SAT) problem,
generate, based on the SAT problem, a SAT problem matrix,
perform, based on the SAT problem matrix, one or more operations to train an untrained machine learning model to generate a trained machine learning model and gradient data, wherein the trained machine learning model comprises a trained partial assignment matrix, and
generate, based on the trained partial assignment matrix and the gradient data and using one or more SAT solvers, a SAT solver output.
